(19) United States
(12) Patent Application Publication
(10) Pub. No.: US 2023/0322117 A1
(43) Pub. Date: Oct. 12, 2023

(54) ELECTRIFIED VEHICLE AND METHOD OF V2V POWER TRADING MANAGEMENT CONTROL FOR THE SAME

(71) Applicants: Hyundai Motor Company, Seoul (KR); Kia Corporation, Seoul (KR)

(72) Inventors: Gi Young Kwon, Seoul (KR); Jae Woo Jeon, Uiwang (KR); Jong Hyeok Park, Hwaseong (KR); Hyun Je Sung, Suwon (KR); Dong Hwan Kwak, Hwaseong (KR)

(21) Appl. No.: 17/977,201

(22) Filed: Oct. 31, 2022

(30) Foreign Application Priority Data
Apr. 11, 2022 (KR) 10-2022-0044680

(51) Int. Cl. B60L 53/66; H04W 4/46; H04W 4/44; B60L 53/53; G06Q 50/06

(52) U.S. Cl. CPC B60L 53/665; H04W 4/46; H04W 4/44; B60L 53/53; G06Q 50/06; B60W 2556/65

(57) ABSTRACT

An electrified vehicle is capable of a V2V power trading through a transaction and a method of a V2V power trading management control for the same. The method of the electrified V2V power trading according to an embodiment of the present disclosure may include: transmitting a power trading offer to a server based on a tradable power of a first vehicle; posting a power for sale on the server according to the power trading offer; and confirming a V2V charging contract to a second vehicle regarding the posted power for sale.

### CROSSREFERENCE TO RELATED APPLICATION

The present application claims priority of Korean Patent Application No. 10-2022-0044680 filled on Apr. 11, 2022, the entire contents of which is incorporated here for all purposes by this reference.

### TECHNICAL FIELD

The present disclosure relates to an electrified vehicle capable of a V2V power trading through a transaction and a method of a V2V power trading management control for the same.

### BACKGROUND

Recently, interest in the environment has increased and the number of electrified vehicles equipped with electric motors as power sources may be increasing as a way to achieve carbon neutrality. In some areas, the concept and planning of a smart city where only electrified vehicles may be driven may be being carried out.

In the related art, managing the energy stored in a battery of the electrified vehicle was primarily discussed in terms of charging control with external objects, but in recent years, the focus has been also on discharging control for external objects, such as the commercialization of vehicle to load (V2L) technology that uses battery energy to run external electrical loads. In addition to the V2L technologies, a vehicle to vehicle (V2V) charging method that uses the energy stored in a battery of one electrified vehicle to charge another electrified vehicle may be also theoretically implementable. Accordingly, a solution where a tradable power of the electrified vehicle may be utilized as a transaction object through a V2V charging method and an added value may be created therewith may be considered.

### SUMMARY

The present disclosure has been proposed to solve the above problem, and an object of the present disclosure is to provide a solution to locate easily a transaction object vehicle to which a tradable power of an electrified vehicle may be transferred through a V2V charging method and to create added value.

Objects to be solved by the present disclosure may not be limited to the aforementioned objects, and the other objects not described above may be evidently understood from the following description by those skilled in the art.

A method of the electrified V2V power trading, to achieve the objects, according to an embodiment of the present disclosure may include: transmitting a power trading offer to a server based on a tradable power of a first vehicle; posting a power for sale on the server according to the power trading offer; and confirming a V2V charging contract to a second vehicle regarding the posted power for sale.

For example, the method may further include performing the V2V charging between the first vehicle and the second vehicle based on the confirmed power trading transaction.

For example, the method may further include determining the tradable power of the first vehicle.

For example, determining the tradable power may include: determining a first index according to a driving behavior tendency of the first vehicle; determining a second index according to a vehicle traveling environment of the first vehicle; determining an estimated power consumption by applying the first index and the second index to an estimated mileage; and determining the tradable power based on a residual power of the first vehicle and the estimated power consumption of the first vehicle.

For example, the determining the tradable power based on a residual power of the first vehicle and the estimated power consumption of the first vehicle may include applying at least one of factors according to a predetermined efficiency margin and cumulative learning to the estimated power consumption.

For example, the power trading offer may include a desired selling price.

For example, the method may further include: keeping the posting of the power for sale on the server in a certain time after the contract for the V2V charging may be confirmed; and confirming a V2V charging contract according to a buying offer of a third vehicle in a case where there may be a buying offer of the third vehicle at a price higher than the desired selling price while the power for sale may be posted on the server.

For example, the method may further include charging a cancellation fee to the first vehicle according to a condition of the V2V charging contract with the second vehicle in a case where the power trading contract may be confirmed according to the buying offer of the third vehicle.

For example, the posting of the power for sale may be immediately suspended in a case where the V2V charging contract may be made at a confirmed buying price higher than the desired selling price.

The electrified vehicle according to the embodiment of the present disclosure may include: a battery; a charging control unit performing a V2V charging in such a manner as to transfer at least some of a residual power of the battery to other vehicles; and a vehicle control unit configured to determine a tradable power that may be an available power for sale in the V2V charging. Here, the vehicle control unit may be configured to determine a first index according to a driving behavior tendency and a second index according to a vehicle traveling environment, determine the estimated power consumption by applying the first index and the second index to the estimated mileage, and then determine the tradable power based on the residual power and the estimated power consumption.

For example, the vehicle control unit may be configured to apply at least one of factors that vary with a predetermined efficiency margin and cumulative learning to the estimated power consumption when determining the tradable power.

According to various exemplary embodiments of the present disclosure as described above, it may be possible to easily locate the transaction object vehicle to which the tradable power of the electrified vehicle may be transferred through the V2V charging method.

In addition, the tradable power may be effectively determined according to a driver and the vehicle traveling environment.

Effects to be obtained from the present disclosure may not be limited to the aforementioned effects, and the other effects not described above may be evidently understood from the following description by those skilled in the art.

### BRIEF DESCRIPTION OF THE DRAWINGS

FIG. 1 shows an example of a power trading system configuration through transactions according to an embodiment of the present disclosure.

FIG. 2 shows an example of an electrified vehicle configuration according to the embodiment of the present disclosure.

FIG. 3 shows an example of a power trading process through transactions according to the embodiment of the present disclosure.

FIG. 4 shows another example of the power trading process through transactions according to the embodiment of the present disclosure.

FIG. 5 shows an example of a process of determining a tradable power according to the embodiment of the present disclosure.

FIG. 6 shows an example of an additional power trading process according to the embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present disclosure will be described in detail by describing disclosed embodiments of the present specification with reference to the accompanying drawings. However, regardless of the reference character, the same or similar constituent elements shall be given the same reference number and the redundant descriptions shall be omitted. The suffixes “module” and “unit” for the constituent elements used in the descriptions below may be given or mixed with the ease of the specification describing, and do not have any distinctive meaning or role in itself each other. In addition, in describing the embodiments of the present specification, if a specific description of the related existing technologies may be deemed to obscure the essential points of the embodiments of the present specification, the detailed description will be omitted. In addition, the accompanying drawings may be intended to facilitate the understanding of the embodiments set forth in the present specification, not to limit the technical idea of the present specification by the accompanying drawings. All alterations, equivalents, and substitutes that may be included within the technical idea of the present disclosure should be understood as falling within the scope of the present disclosure.

The ordinal number terms first, second, and so on may be used to describe various constituent elements but should not limit the meanings of these constituent elements. These terms may be only used to distinguish one constituent element from another.

It should be understood that a constituent element, when referred to as being “connected to” or “coupled to” a different constituent element, may be directly connected to or directly coupled to the different constituent element or may be coupled to or connected to the different constituent element with a third constituent element in between. In contrast, it should be understood that a constituent element, when referred to as being “directly coupled to” or “directly connected to” a different constituent element, may be coupled to or connected to the different constituent element without a third constituent element in between.

A noun in singular form has the same meaning as when used in plural form, unless it has a different meaning in context.

It should be understood that, throughout the present specification, the term “include,” “have,” or the like may be intended to indicate that a feature, a number, a step, an operation, a constituent element, a component, or a combination thereof may be present, without precluding the possibility that one or more other features, numbers, steps, operations, constituent elements, components, or a combination thereof will be present or added.

In addition, the term Unit or Control Unit, which may be included in the Hybrid Control Unit (HCU), Vehicle Control Unit (VCU), or the like, may be a widely used term for the Controller that controls vehicle-specific functions and does not refer to the Generic Function Unit. For example, each control unit may include a communication device that communicates with other control units or sensors to control assigned functions, a memory that stores an operating system or logic commands and input/output information, and one or more processors that perform the judgments, calculations, and decisions required to control assigned functions.

An embodiment of the present disclosure proposes a power trading system capable of power transactions through the V2V charging method in a manner that locates transaction object vehicles to which a tradable power of an electrified vehicle may be transferred, an electrified vehicle performing the power trading, and a management control method for the power trading.

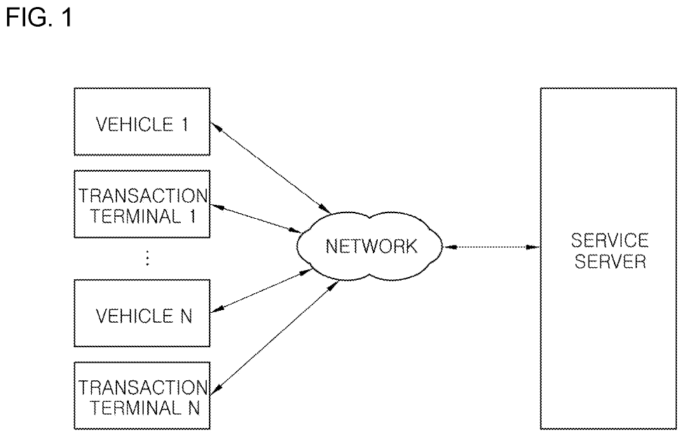

FIG. 1 shows an example of a power trading system configuration through transactions according to the embodiment of the present disclosure.

Referring to FIG. 1, the power trading system according to the embodiment includes a plurality of vehicles, a plurality of transaction terminals, and a service server. The vehicles, the transaction terminals, and the service server thereof may be configured to communicate with each other through a network. At this point, it may be clear to those skilled in the art that the network may not be limited to any form as long as the data exchange may be available between each object by either wired or wireless. For example, the service server may be connected to a network via wired communication, and each transaction terminal and each vehicle may be connected to the network via wireless communication. In addition, the communication between the vehicle and the transaction terminal may be made through a Connected Car Service (CCS) server (not illustrated). In addition, the vehicle and the transaction terminal may be paired and interfaced through a single account in the CCS.

It may be desirable for the vehicle to be an electrified vehicle with sockets that may be plugged in for the power trading with other vehicles, and the type of electrified vehicle may not be limited to any form of an electric vehicle (EV), a plug-in hybrid electric vehicle (PHEV), a fuel cell electric vehicle (FCEV), or the like, as long as the built-in battery may be discharged through the coupled plug.

In addition, the transaction terminal may be a mobile terminal such as a smart phone or a smart tablet, but it may also be a fixed type terminal such as a desktop personal computer (PC).

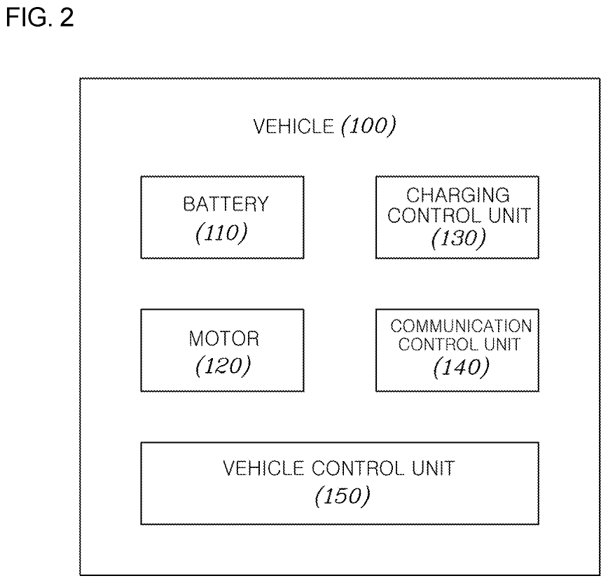

Next, referring to FIG. 2, a vehicle configuration applicable to the embodiment will be described.

FIG. 2 shows an example of the electrified vehicle according to the embodiment of the present disclosure.

Referring to FIG. 2, the electrified vehicle 100 according to the embodiment may include a battery 110, a motor 120, a charging control unit 130, a communication control unit 140, and a vehicle control unit 150. FIG. 2 focuses on constituent elements related to the embodiment of the present disclosure, and of course, more constituent elements may be included in an actual implementation of the vehicle. Hereinafter, each constituent element will be described in detail.

The battery 110 may have the appropriate voltage to drive the motor 120, store the power supplied by the plug coupled to the socket (not illustrated), or discharge power to the outside through the plug.

The motor 120 provides driving force to the vehicle 100. A hybrid electric vehicle may generate electricity by engine driving, and the electricity generation may also be performed through regenerative braking.

A charging control unit 130 may support at least one method, either slow charging or rapid charging, depending on the type of charging. For this purpose, the charging control unit 130 may include an On-board Charger (OBC), Power Line Communication (PLC) control unit, or the like. Particularly, regarding the embodiment of the present disclosure, the charging control unit 130 may be configured to control the V2V charging process. The power trading process according to the embodiments of the present disclosure may be based on the V2V charging, but may not be specific to the type or kind of V2V charging protocol for performing the V2V charging. Thus, a specific description in detail of the V2V charging protocol will be omitted. Of course, instead of the additional V2V protocol, the V2V method may be replaced by the commercialized V2L method in such a manner that a power-supplying electrified vehicle performs discharging and a power-receiving electrified vehicle plugs a slow charging device (e.g. in-cable control box (ICCB) and the like) into the V2L socket.

The communication control unit 140 may be configured to perform short-range wireless communication with the transaction terminal and wireless communication for a telematics center or a connected car service server.

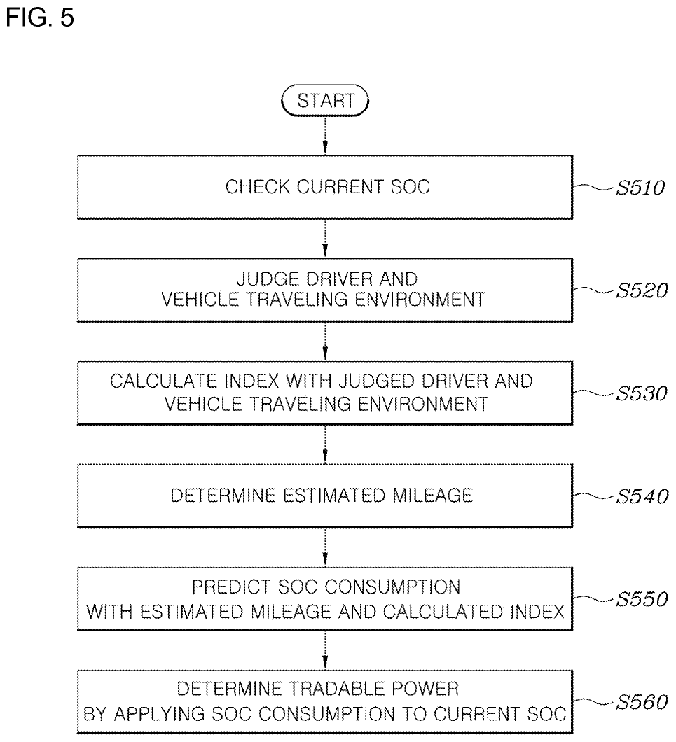

The vehicle control unit 150 may be configured to determine the tradable power based on the battery 110 status, driving environment information, and the estimated distance to travel. And then, the vehicle control unit 150 may be configured to transmit the resulting amount of power to the outside by the communication control unit 140 or transfer the power of the battery 110 to other vehicles by the control of the charging control unit 130. An example of how to determine the specific tradable power will be described below referring to FIG. 5. The vehicle control unit 150 may be an HCU for Plug-in Hybrid Electric Vehicles (PHEV) or a VCU for Electric Vehicles (EV), but this may be only for an exemplary purpose and may not be necessarily limited to the examples.

Hereinafter, the power trading process according to various embodiments will be described based on the detailed configurations of the power trading system and the electrified vehicle.

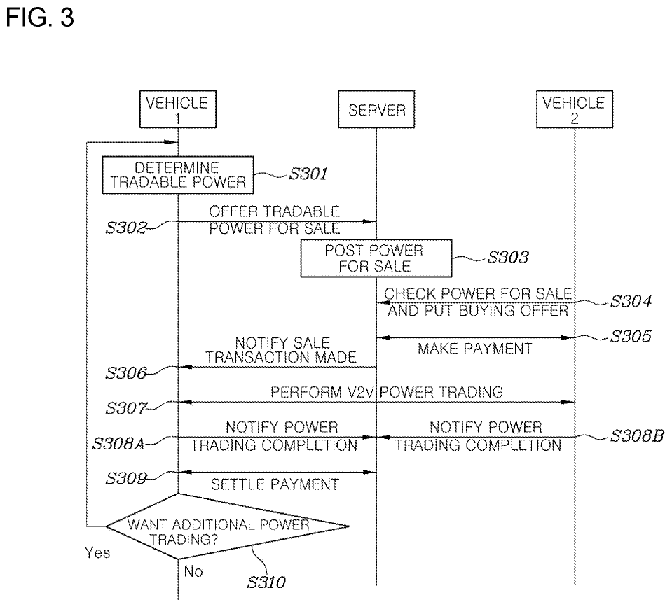

A buyer-locating-matching method may be applied to the power trading process in such a manner that the tradable power of one's own vehicle may be determined and posted to a service server in a case where an owner of the power-supplying vehicle may be willing to trade the power. Here, the server-based process of posting the power for sale and matching a buyer may be performed either through communication between the vehicle and the server, or through communication between the transaction terminal and the server. First, referring to FIG. 3, a method of the vehicle-to-server communication may be described.

FIG. 3 shows an example of a power trading process through transactions according to the embodiment of the present disclosure.

Referring to FIG. 3, the tradable power may be initially determined in vehicle 1 (S301). The tradable power may mean the surplus power excluding power scheduled or predicted to be used for driving before the next charge from power currently held in the battery, and a specified efficiency margin may also be applied to the power scheduled or predicted to be used. Referring to FIG. 5, the detailed process of determining the tradable power will be described below. Here, the step may be performed in either case of activation of the power trading function by the User Setting Menu (USM), decision command input through user's specified menu operation, or specified time period. However, the case may be only for an exemplary purpose and may not be necessarily limited.

Once the tradable power may be determined, the vehicle 1 may set at least some of the tradable power as the tradable power to sell on the server and thus offer the tradable power on the server (S302). According to the embodiment, minimum trading power may be set on the server, and a trading offer may be made in a case where the tradable power or the tradable power to sell may be more than the specified minimum trading power. On this occasion, the trading offer may include the current location of the vehicle 1, the desired place of the transaction, or the unit price of the trading.

The process of putting the trading offer on the server or setting the tradable power to sell by the vehicle 1 may be performed through a specified user interface available from the Audio/Video/Navigation (AVN) system, and the like, but may not be necessarily limited to such a user interface.

The power for sale may be posted on the server (S303) by the trading offer in the form of a web page or a readable type through a specified application.

The power transaction menu displayed on the AVN system or the power for sale posted through the power transactions application may be checked by a vehicle 2, and the user of vehicle 2 may select an offered power therefrom that meets the conditions (transaction place, unit price, amount of power, and the like.) and may put a buying offer on the server (S304).

Upon the buying offer, a payment for the selected power for sale may be made (S305). The payment may be made definitely using a variety of payment methods, such as card payments, micro-transactions, bank transfers, in-car payments, and the like, which may be widely used in e-commerce. Here, depending on the payment method, communication with a separate payment server may be required. The present disclosure may not be limited to the payment methods. Thus, the detailed descriptions of the payment process for each method of the payment will be omitted.

Once the payment may be made, the server sends a notification to the vehicle 1 that a transaction of the power for sale may be made (S306). Accordingly, the vehicle 1 and the vehicle 2 may meet at a place determined by the posted conditions or by consultation, and perform V2V power trading by plug-in connection therebetween (S306).

Afterward, each vehicle notifies the server of the completion of the power trading (S308A, S308B), and then the payment may be settled between the server and the vehicle 1 (S309). Here, the term payment settlement may mean the procedure that the amount charged for the power trading may be transferred to the bank account registered by the owner or user of the vehicle 1, or mean the procedure that alternative goods such as deposits, points, or the like may be entered into the account.

Afterward, in a case where the user of the vehicle 1 wants to trade additional power (S310), then the step S301 may be performed again.

In FIG. 3, the payment S305 may be made prior to the power trading S307 upon the buying offer S304, but the payment S305 may be made after the power trading S307 may be performed according to the embodiment.

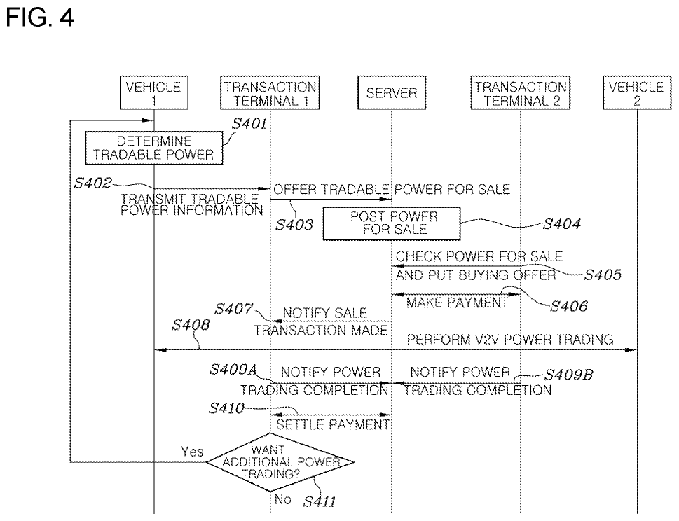

In FIG. 3, a flowchart is illustrated assuming that the power sales and the power buying may be performed through the vehicle. However, the sales and buying may be performed through the transaction terminal. This is to be described by referring to FIG. 4. FIG. 4 shows another example of a power trading process through transactions according to the embodiment of the present disclosure.

In FIG. 4, it may be assumed that the vehicle 1 may be in conjunction with the transaction terminal 1 by one connected service account, and that the vehicle 2 may be in conjunction with the transaction terminal 2 by another connected service account. In addition, unlike in FIG. 3, in FIG. 4, it may be assumed that the entity for the communication with the server may be each transaction terminal, not each vehicle. Except for the difference in the execution entity, the detailed operation of each step may be similar to the case of FIG. 3. Thus, the overlapping detailed information may be omitted. In addition, the vehicle 1 and the transaction terminal 1 may communicate directly with the vehicle 2 and the transaction terminal 2, respectively, through short-range wireless communication. Alternatively, the vehicle 1 and the transaction terminal 1 may perform communication through the telematics server or the connected car service server.

Referring to FIG. 4, the tradable power may be initially determined in the vehicle 1 (S401). This step may be performed in either case that the determination request may be made by the transaction terminal 1, or by the specified time period in vehicle 1. However, the case may be only for an exemplary purpose and may not be necessarily limited.

Once the tradable power is determined, the vehicle 1 transmits information on the tradable power to the transaction terminal 1 (S402), and the transaction terminal 1 may offer the tradable power on the server (S403) in a manner that sets at least some of the tradable power as the tradable power to sell on the server.

The process of putting the trading offer on the server or setting the tradable power to sell by the transaction terminal 1 may be performed using the user interface available through an application for the power transactions, but may not be necessarily limited to this user interface. For example, the power transaction function may be implemented in the form of one function in the connected car service applications.

The power for sale may be posted on the server (S404) by the trading offer in the readable forms such as a web page type or a specified application.

The power for sale posted through the power transaction applications or the connected car service applications may be checked by the transaction terminal 2, and the user of the transaction terminal 2 may select an offered power therefrom that meets the conditions (transaction place, unit price, amount of power, and the like.) and may put a buying offer on the server (S405).

Upon the buying offer, a payment for the selected power for sale may be made (S406). The payment may be made definitely using a variety of payment methods, such as card payments, micro-transactions, bank transfers, in-car payments, and the like, which may be widely used in e-commerce. Here, depending on the payment method, communication with a separate payment server may be required. The present disclosure may not be limited to the payment methods. Thus, the detailed descriptions of the payment process for each method of the payment will be omitted.

Once the payment is made, the server sends a notification to the transaction terminal 1 that a transaction of the power for sale is made (S407). Accordingly, the vehicle 1 and the vehicle 2 may meet at a place determined by the posted conditions or by consultation, and perform V2V power trading by plug-in connection therebetween (S408).

Afterward, each transaction terminal notifies the server of the completion of the power trading (S409A, S409B), and then the payment may be settled between the server and the transaction terminal 1 (S410). Here, the term payment settlement may mean the procedure that the amount charged for the power trading is transferred to the bank account registered by the owner or user of the transaction terminal 1 (or the vehicle 1), or that alternative goods such as deposits, points, or the like are entered into the account of the connected car service.

Afterward, in a case where the user of the transaction terminal 1 wants to trade additional power (S411), then the step S401 may be performed again.

Hereinafter, referring to FIG. 5, the process of determining the tradable power will be described.

FIG. 5 shows an example of a process of determining a tradable power according to the embodiment of the present disclosure. Each process in FIG. 5 may be performed on the vehicle control unit 150 of the FIG. 2. However, the process is for an exemplary purpose only and may not be necessarily limited thereto.

Referring to FIG. 5, the State of Charge (SOC) may be checked first from the vehicle (S510).

In addition, a driver and a vehicle traveling environment may be judged in the vehicle (S520).

Here, the judgment for the driver may be performed through the means such as a smart key being coupled with a driver profile that may be detected in the vehicle, the driver profile selected through the AVN system, the driver facial recognition taken through in-cabin camera, fingerprint recognition, and identification of smart devices connected through short-range wireless communication (e.g. Bluetooth), and the like, but this is for an exemplary purpose only and not necessarily limited thereto. However, the purpose of the judgment for the driver may be to determine a driving behavior tendency corresponding to the driver. The driving behavior tendency of the driver may be divided into multiple levels, eco, normal, and sport. The driving behavior tendency may be driver-specific information stored in the vehicle based on at least one from the cumulative selection result of a normal drive mode, the learning of an accelerator pedal operation pattern, average vehicle speed, average acceleration, or lightning acceleration.

In addition, the vehicle traveling environment may mean a driving environment such as air conditioning settings, ambient air temperature, and the like determined over the initial section of a predetermined driving cycle (for example, 10 minutes after the start of the driving).

Once the judgment for the driver and the vehicle traveling environment may be made, an index calculation based on the judgment may be achieved (S530). Here, the index may mean factors related to the energy used for a unit distance of the vehicle traveling. For example, the index for the vehicle traveling environment may be set as shown in Table 1 below.

TABLE 1

| Ambient Air Temperature | FATC Condition | EC index |
|---|---|---|
| 23° C. or higher | AC ON | 22 |
| | HEATER ON | 21 |
| | OFF | 20 |
| from −7° C. to less than 23° C. | AC ON | 12 |
| | HEATER ON | 11 |
| | OFF | 10 |
| under −7° C. | AC ON | 32 |
| | HEATER ON | 31 |
| | OFF | 30 |

In Table 1, the Full Automatic Temperature Control (FATC) indicates the status of the FATC, and it is noted that the index at the same ambient air temperatures depends on whether Air Conditioning (AC) or Heating may be ON or OFF. In Table 1, the higher the index, the bigger the energy consumption at the unit distance for a vehicle traveling.

Similar to the above-mentioned index of the vehicle traveling environment, the index may also be assigned by the driving behavior tendency to the recognized driver.

Once the index is calculated, the estimated mileage of a vehicle traveling may be determined (S540). Here, the estimated mileage is a predicted traveling distance based on the current battery energy until the next charging. The estimated mileage may be directly entered by the driver, determined by setting a destination on the AVN system, or determined by the cumulative learning-based Big Data and the like at the current time, but this is only for an exemplary purpose and not necessarily limited thereto.

Once the estimated mileage is determined, SOC consumption may be predicted by applying the index of the driving behavior tendency and the index of the vehicle traveling environment to the estimated mileage (S550).

Accordingly, an estimated residual SOC may be calculated by subtracting SOC consumption from a current SOC, and the estimated residual SOC may be converted into the amount of power (e.g. in kWh) to determine the tradable power finally (S560). Here, the estimated residual SOC may be converted into tradable power as it is. However, according to the embodiment of the present disclosure, a predetermined margin SOC considering the travel distance for the power trading or a minimum SOC for powertrain efficiency may be further subtracted from the current SOC, and then the estimated residual SOC may be converted finally into tradable power. On the other hand, a predetermined factor calculated based on the learning of cumulative vehicle traveling data of the vehicle may be applied to the estimated residual SOC by a multiplication operation or the like.

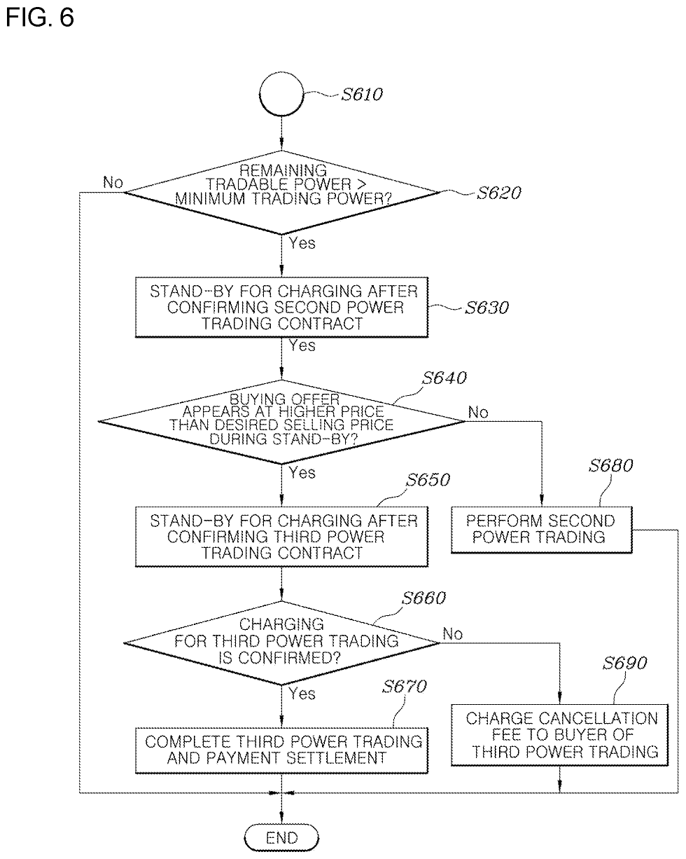

Meanwhile, according to the present embodiment of the present disclosure, the additional power trading process (e.g. the subsequent processes to Yes of S310 or Yes of S411) may be performed in multiple orders. This is to be described by referring to FIG. 6.

FIG. 6 shows an example of an additional power trading process according to the embodiment of the present disclosure.

Referring to FIG. 6, according to an additional trading decision (S610) such as proceeding to Yes from the step S310 of FIG. 3, proceeding to Yes from the step S411 of FIG. 4, or the like as described above, it may be determined whether the remaining tradable power out of the first power trading is bigger than the specified minimum trading power or not (S620).

In a case where the remaining tradable power is bigger than the specified minimum trading power (Yes of S620), the owner of the vehicle may put a second power trading offer in a manner that assigns a desired selling price through the vehicle or the transaction terminal as subscribed above. If there is a buying offer for the posted power for sale according to the second trading offer and the contract is confirmed, the owner of the vehicle may be on stand-by prior to joining the vehicle of the buying offer to perform V2V charging therebetween (S630).

During the stand-by, in a case where a buyer appears to be willing to purchase the power at a price higher than the desired selling price (Yes of S640), a third power trading offer is confirmed at a price higher than the desired selling price and the vehicle is on stand-by for the newly confirmed V2V charging (S650). Here, confirming the third power trading offer during stand-by may mean that the server keeps the posting of the second power for sale in a certain time after the contract for the second power trading offer is confirmed. In addition, as the third power trading offer is confirmed and the buyer of the second power trading offer is unable to charge the vehicle, a cancellation fee of the second power trading offer is to be charged to the vehicle owner accordingly by the server, and at least some of the cancellation fee of the second power trading offer may be transferred to the buyer of the second power as compensation for the cancellation. In addition, according to the embodiment, in a case where the predetermined grace time of the server posting of the second power trading offer passes after the second power trading offer is confirmed, the seller of the second power trading offer (that is, the vehicle owner) becomes beyond revoke. Nonetheless, in a case where V2V charging is not provided to the buyer of the second power trading offer for the reasons of the vehicle owner, the predetermined penalty may be given to the vehicle owner. During the time of the power of sale posting described above, to prevent the third power trading deal, a firm offer set at a higher trading price than the desired selling price may be paid. In this case, the server may immediately suspend the offer posting of the second power trading.

Afterward, in a case where the charging is confirmed (Yes of S660) in a manner that the buyer and the vehicle owner of the third power trading meet together with their vehicles and perform the V2V charging, the third power trading is to be completed and the vehicle owner may receive the payment settlement for the third power trading from the server accordingly (S670).

In contrast, in a case where the buyer of the third power trading cancels the buying offer (No of S660), the predetermined cancelation fee is charged to the buyer of the third power trading, and at least some of the cancellation fee may be reimbursed to the vehicle owner (the seller) (S690).

On the other hand, during the stand-by, in a case where no buyer appears to purchase the power at a price higher than the desired selling price (No of S640), as per the second power trading conditions, the power trading transaction (e.g. V2V charging and payment settlement) is performed for the buyer (S680).

As described up to here, the power trading according to the embodiments of the present disclosure may be also useful for the case where an extra removable battery is fitted in addition to a fixed type main battery fitted in a vehicle. For example, the capacity of the main battery is not capable of covering the estimated mileage and thus full charged removable battery is additionally fitted in the vehicle, but the actual mileage is shorter than expected, leaving a large amount of power in the removable battery after vehicle traveling. In this case, the power trading through V2V charging may be useful. In addition, in a case where the aggregated energy management of the main battery with the removable battery is performed, the residual SOC may be used to determine the tradable power by using the aggregated SOC rather than the residual SOC of the main battery.

In addition, in a case where a preferred trading area is selected upon the trading offer, the tradable power may be calibrated by variance in SOC according to the travel path from the current location to the preferred trading area. For example, in a case where a long steel section exists on the path to the preferred trading area, not only a decrease in the SOC consumption for the travel but also the battery charging by a regenerative braking may be expected. Thus, bigger power than the determined tradable power of the vehicle may be set as the power for sale.

In addition, in a case where the buyer wants the power trading in a different area from the preferred trading area of the seller in performing the buying offer, the amount due may increase by the distance therebetween.

The present disclosure described above may be implemented as non-transitory computer-readable code on the media on which the program is recorded. A computer-readable medium includes all kinds of recording devices in which computer system-readable data may be stored. Examples of the computer-readable media may be hard disk drives (HDD), solid state disks (SSD), silicon disk drives (SDD), ROM, RAM, CD-ROM, magnetic tapes, floppy disks, optical data storage devices, and the like. Therefore, the detailed descriptions provided above should not be limitedly interpreted in all respects and should be considered to be exemplary descriptions. The scope of the present disclosure may be determined by the legitimate construction of the following claims. All equivalent modifications to the embodiments of the present disclosure fall within the scope of the present disclosure.

1. A method of an electrified V2V power trading, the method comprising:
transmitting a power trading offer to a server based on a tradable power of a first vehicle;
posting a power for sale on the server according to the power trading offer; and
confirming a V2V charging contract to a second vehicle for the power for sale.

2. The method of claim 1, further including:
performing the V2V charging between the first vehicle and the second vehicle based on the V2V charging contract.

3. The method of claim 1, further including:
determining the tradable power of the first vehicle.

4. The method of claim 3, wherein the determining the tradable power includes:
determining a first index according to a driving behavior tendency of the first vehicle;
determining a second index according to a vehicle traveling environment of the first vehicle;
determining an estimated power consumption by applying the first index and the second index to an estimated mileage; and
determining the tradable power based on a residual power of the first vehicle and the estimated power consumption of the first vehicle.

5. The method of claim 4, wherein determining the tradable power based on the residual power of the first vehicle and the estimated power consumption of the first vehicle includes:
applying at least one of factors according to a predetermined efficiency margin and cumulative learning.

6. The method of claim 1, wherein the power trading offer includes a desired selling price.

7. The method of claim 6, further including:
keeping the posting of the power for sale on the server in a certain time after the V2V charging contract is confirmed; and
confirming a second V2V charging contract according to a buying offer of a third vehicle when the buying offer of the third vehicle is at a price higher than the desired selling price while the power for sale is posted on the server.

8. The method of claim 7, further including:
charging a cancellation fee to the first vehicle according to a condition of the V2V charging contract with the second vehicle in a case where the second V2V charging contract is confirmed according to the buying offer of the third vehicle.

9. The method of claim 7, wherein the posting of the power for sale is immediately suspended in a case where the V2V charging contract is made at a confirmed buying price higher than the desired selling price.

10. A computer-readable medium comprising a program stored in memory and when executed by a processor is configured to execute a method of the electrified V2V power trading according to claim 1.

11. An electrified vehicle comprising:
a battery;
a charging control unit configured to perform a V2V charging in such a manner as to transfer at least some of a residual power of the battery to other vehicles; and
a vehicle control unit configured to determine a tradable power that is an available power for sale in the V2V charging,
wherein the vehicle control unit is configured to determine a first index according to a driving behavior tendency and a second index according to a vehicle traveling environment, determine an estimated power consumption by applying the first index and the second index to an estimated mileage, and then determine the tradable power based on the residual power and the estimated power consumption.

12. The electrified vehicle of claim 11, wherein the vehicle control unit is further configured to apply at least one of factors that vary with a predetermined efficiency margin and cumulative learning to the estimated power consumption.
